(19) United States
(12) Patent Application Publication
(10) Pub. No.: US 2008/0082718 A1
(43) Pub. Date: Apr. 3, 2008

(54) Type structure of an adapter card

(75) Inventor: Chien-Yuan Chen, Banciao City (TW)

Correspondence Address: BACON & THOMAS, PLLC, 625 SLATERS LANE, FOURTH FLOOR, ALEXANDRIA, VA, 22314, US

(73) Assignees: Power Digital Card Co., Ltd., Banciao City (TW); Chien-Yuan Chen, Banciao City (TW)

(21) Appl. No.: 11/785,785

(22) Filed: Apr. 20, 2007

(30) Foreign Application Priority Data
Oct. 3, 2006 (TW) 95140187

(51) Int. Cl. G06F 13/20

(52) U.S. Cl. 710/313

(57) ABSTRACT

The new type structure of an adapter card in the present invention is an adapter card in combination of memory card specifications and the type of the universal serial bus (USB), wherein a detachable separable block is disposed on one end of the universal serial bus (USB);

By means of temporal removal or stacking insertion said detachable separable block from or on the universal serial bus (USB), the adapter card becomes an integral memory card with dual interface of memory card and the USB in consequence of the terminal to be inserted conforming to and being compatible with the specifications of the USB port;

Moreover, by adopting the material property of the thermoplastic and thermosetting resin in association with manufacturing process, the product quality and the service life are promoted owing to the success and smoothness in assembly and dismantling of said (separable block) being boosted.

### FIELD OF THE PRESENT INVENTION

The new type structure of an adapter card in the present invention is particular for the structural design and manufacturing process of a memory card in providing the storage and retrieval of the data and information.

### BACKGROUND OF THE INVENTION

Going with the increasing development and progress of the science and technology, the related electronic information product such as personal computer, MP3, digital camera, video recorder with camera and so forth of multimedia product become very popular, and the requirement or demand for the digital storage device in application of these said multimedia product from the consumers is also increased relatively. But, the specifications, size and apparatus of these said multimedia products are different either from product model to product model or form manufacturer to manufacturer.

The digital storage devices of memory card and portable disk and so on already become the personal belongings of many computer users; Comparing with the diskette, the memory card and portable disk are not only small size, large storage capacity and quick storage/retrieval but also are hardly wetted and destroyed with quick read/write so that the memory card and portable disk become the indispensable accessory of the computer and the peripherals of the computer.

For the portable disk, the equipped transmission interface of the universal serial bus (USB), which being generally used in the common existing computers and peripherals, possesses the plug-and-play (PnP) function without installation of additional drive program to most operating systems; Thereby, such design is not only easy in installation and running for the vendors but also a way of quick and simple operation and cheap price for the users.

Contrarily, for the memory card, owing to each digital peripheral for every device model is only applied to limited specific specifications, they are always fabricated into variety of type and specification such as Smart Media Card, Secure Digital Card, Multi Media Card, Memory Stick Card, CF Card, XD Card and so forth to suit with digital devices such as digital camera, palm player, MP3, PDA and cellular phone and so forth in variety of model and brand; The possibility of exchange substitution is very low owing to neither is the same specifications and size nor is the same corresponding connector for each memory card; Hence, the consumer not only has to buy many different memory cards but also has often bought wrong memory card in useless condition with incompatible specification.

Therefore, some businessmen simultaneously put up the universal serial bus (USB) and memory card interface with possible specifications of anyone in Secure Digital Card, Multi Media Card, CF Card and so on; although such structure can achieve the data and information transmission in dual interface manner, some existing drawbacks to be urgently improved are as below:

For the fabricating process of memory card, a chip module including flash memory, control chip, passive component and so on together with a connected I/O contact connector at substrate front edge are mounted on the same substrate so as to construct the circuitry required, then the ultrasonic fusion or via mold-press, spot-glue-dispensing and so on are co-operated to closely stick which on the said substrate; If thermoplastic resin is used as manufacturing material, the production might be speeded up, but the produced memory card will become too hard in lack of suitable flexibility demanded and result in easy fracture under over pressure. Besides, because of the size and thickness of the memory card is different form that of the universal serial bus (USB), the memory card will be easily hooked by or withstand against the conducting terminal in the card connector during insertion into the card connector as height drop and unevenness in the shape and surface of the memory card; Hence, the deformation of the conducting terminal in the card connector will happen then seriously affect the precision and stability of the card insertion and conduction in between.

Through long laborious study, research and experiment in addition to the relevant manufacturing experience background, the inventor of the present invention eventually develops and designs out the product structure and fabricating process of the present invention.

### SUMMARY OF THE INVENTION

Accordingly, the main object of the present invention is to provide a memory card fabricating process of not only quick production but also increasing the quality and yield.

The further object of the present invention is to provide a memory card for storage and retrieval of the data and information with not only the specification and size in dual interface of both in conforming to the universal serial bus and memory card interface but also eliminating the risk in affecting the standard thickness and shape of the memory card.

For achieving the objects aforesaid, the new type structure of an adapter card of the present invention combines both advantage of thermosetting and thermoplastic resin so as to let the dual interface adapter card of memory card and the USB have not only high production speed and yield but also easy assembly and better elasticity of flexibility without deformation or distortion and fracture; Additionally, by means of the contrivance in demountable separable block of temporal removal form or stacking on the universal serial bus (USB), the memory card can be made to have the shape and size of memory card or conform to the application specification of the USB.

As for the detailed structure and the practical effect as well as the application principle, it can be fully cognized and comprehended by following description in association with accompanying figures referred:

### BRIEF DESCRIPTION OF THE DRAWINGS

FIG. 1 is the structure illustrative view for one preferred embodiment of the present invention.

FIG. 2 is another structure illustrative view for one preferred embodiment of the present invention taken from inverted side.

FIG. 3 is the assembling illustrative view for one preferred embodiment of the present invention.

FIG. 4 is the cross section illustrative view for one preferred embodiment of the present invention.

FIG. 5 is the perspective assembled illustrative view for one preferred embodiment of the present invention.

FIGS. 6 and 7 are the illustrative view in operation steps for one preferred embodiment of the present invention.

FIG. 8 is the structure illustrative view for other preferred embodiment of the present invention.

FIG. 9 is the flow chart of the fabricating process for one preferred embodiment of the present invention.

FIG. 10 is the flow chart of the fabricating process for other preferred embodiment of the present invention.

### DETAILED DESCRIPTION OF THE PREFERRED EMBODIMENTS

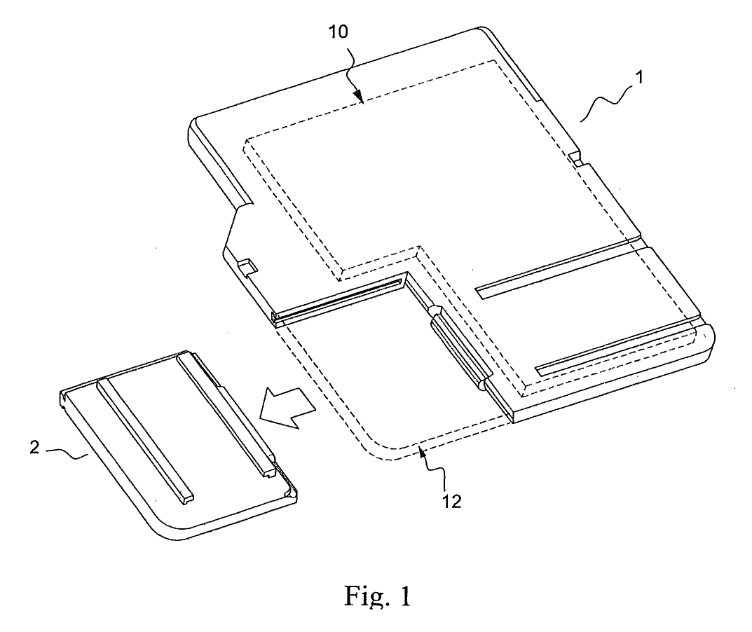

The FIG. 1 of the structure illustrative view for one preferred embodiment of the present invention is referred in association with other figures; As shown in the figures, the present invention mainly comprises a card body 1 and a separable block 2, wherein,

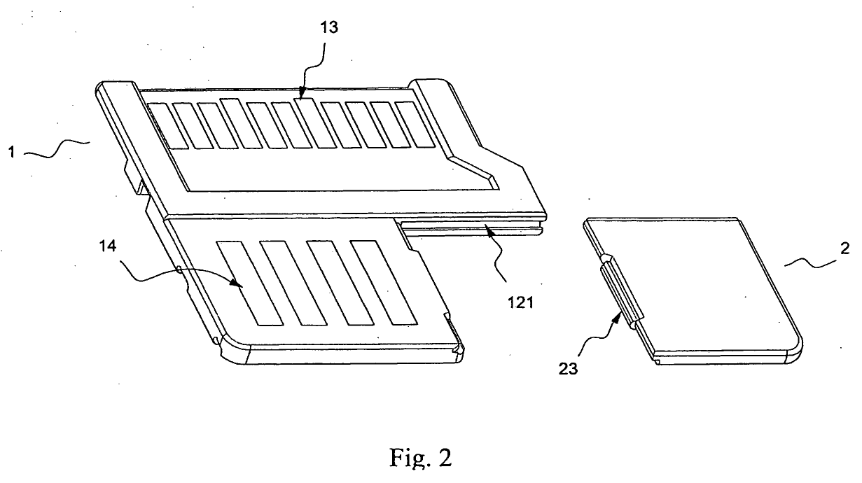

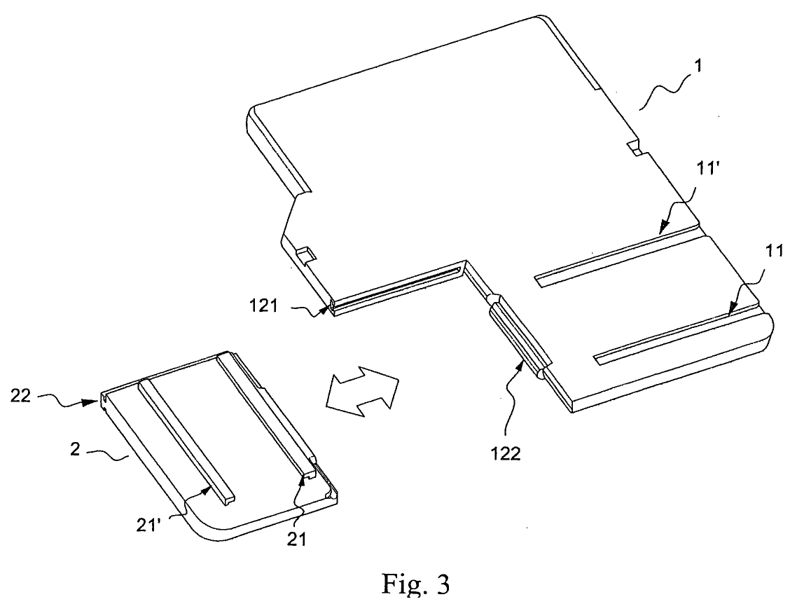

The card body 1, master card, which being made of thermoplastic resin through extrusion molding and packaging, has a chip module 10 mounted on the substrate as well as the memory card specification and a set of exposed I/O contacts 13 of said chip module disposed at one end of said card body 1 (please refer to the FIG. 2); The specifications of the memory card can be anyone miniature card of Secure Digital Card, Multi Media Card, MS Pro Card series, XD Card, Mini SD and so forth; A right angled cut recess 12, which being formed at the other end of said card body 1 has an indented (second insertion slot 121 and a snap buckle 122 for hooking up with the separable block 2 respectively disposed on each of both sides forming the right angle in said cut recess 12; Other than said cut recess 12, the rest part of said card body 1, which conforming to the size of the universal serial bus (USB), has a pair of horizontal parallel indented first insertion slots 11 and 11′ are transversely juxtaposed on one surface of said card body 1 as well as has a set of I/O contacts 14 of the universal serial bus (USB) formed on the inverted surface said card body 1 (please refer to FIGS. 2 and 3);

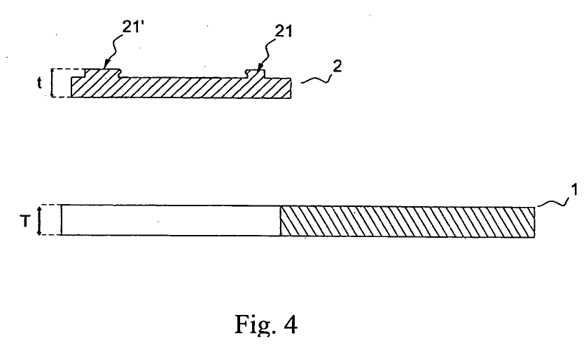

The separable block 2, sub-card, whose shape conforming to the outline of said cut recess 12 on said card body 1, has a protruded second fastener 22 and a snap buckle 23 for coupling with the corresponding said indented second insertion slot 121 and snap buckle 122 on said cut recess 12 of said card body 1 respectively disposed on each of both sides forming the right angle in said separable block 2 as well as has a pair of horizontal parallel indented first fasteners 21 and 21′ juxtaposed on one surface of said separable block 2 for coupling with the corresponding said pair of first insertion slots 11 and 11′ on said card body 1; Wherein, said pair of juxtaposed first fasteners 21 and 21′ and pair of first insertion slots |11 and 11′ can be contrived as either stout-one with slim-one set manner or slim-one with stout-one set manner in different specifications so as to avoid happening of wrong action due to incorrect inserting direction by the user; Besides, said pair of juxtaposed first fasteners 21 and 21′ can also be arranged in anyone manner of both-in-same-direction, back-to-back-direct-outward and face-to-face-direct-inward, while the face-to-face-direct-inward arrangement manner is adopted in the exemplary embodiment; Moreover, the total thickness t of said separable block 2 plus said pair of first fasteners 21 and 21′ on which must be not greater than the thickness T of said card body 1 so as to avoid said separable block 2 being higher than said card body 1 upon completion of assembly (please refer to the FIG. 4); Thus, both of the failure in inserting said adapter card into the connector of related electric device due to whose bulge and the damage of the conducting terminal in the connector can be prevented.

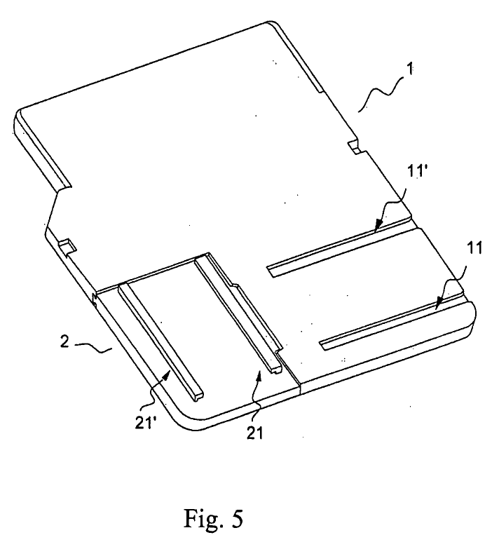

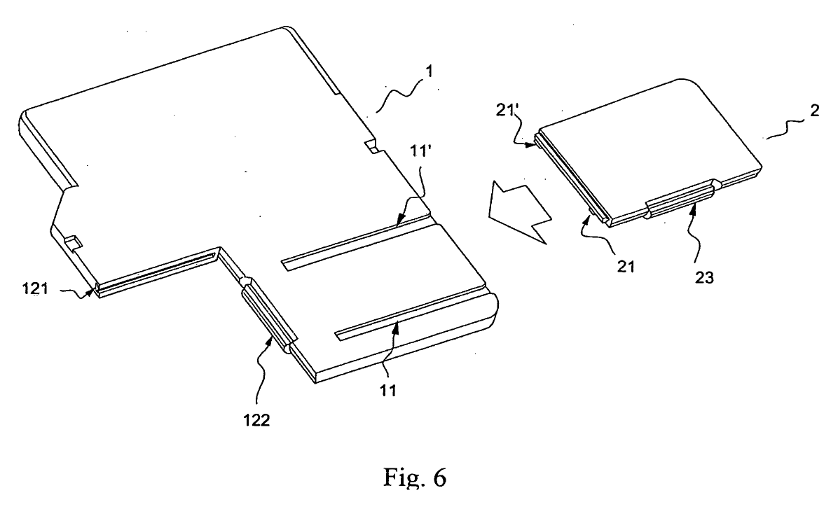

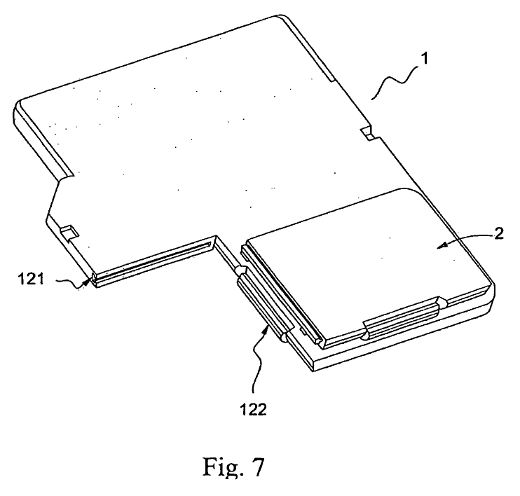

During practical use, both of said card body 1 and separable block 2 are assembled into an integral unit of finished adapter card (please refer to the FIG. 5); Said separable block 2, if which being dismounted from said card body 1 (please refer to the FIG. 6), can be stacking mounted on the top of said card body 1 by means of sliding said whose first fasteners 21 and 21′ into said first insertion slots 11 and 11′ on said card body (please refer to the FIG. 7); Thereby, for the attached card of thin-type such as Mini SD, not only its thickness can meet that of the USB port but also the risk of loss and dropping off can be avoid; Meanwhile, by means of the arrangement of said pair of first insertion slots 11 and 11′ on said card body 1 together with said pair of first fasteners 21 and 21′ on said separable block 2, said separable block 2 cab be precisely positioned and locked in the predetermined destination on said card body |1 with braking function of anti-idle ability so as to prevent such product from failure of normal function due to mistake and inadvertence from the user. Certainly, if the thickness of the suitable card meet that of specification for inserted USB port such as Secure Digital Card, XD Card and so forth, the adapter card can be directly used for insertion by just pulling out and removing said separable block away from said card body 1 without necessity of stacking and mounting it on said card body 1; Thereby, the dual interface of memory card specification and the USB specification is finished.

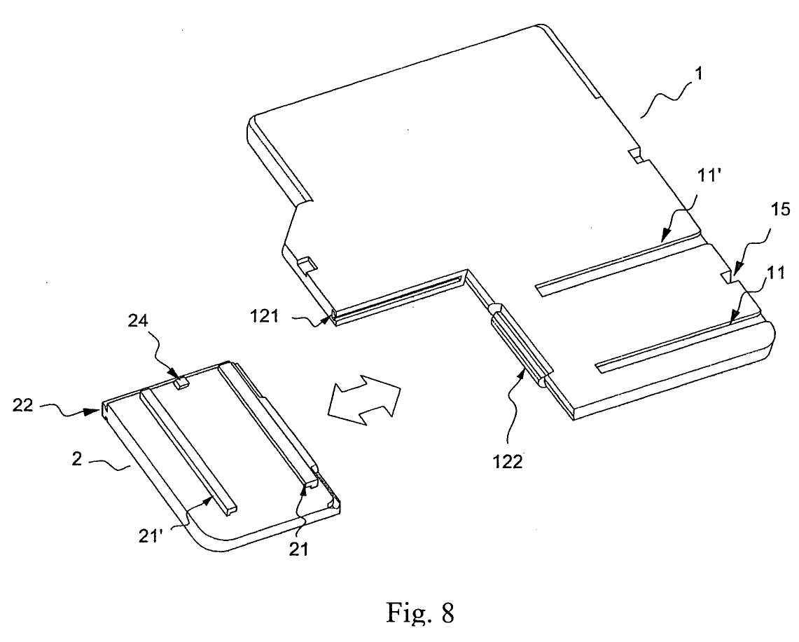

The difference of the structure illustrative view for other preferred embodiment of the present invention in the FIG. 8 from above exemplary embodiment aforesaid is that an additional notch 15 being created on the edge of said card body 1 as well as an additional jut 24 being created at the corresponding edge of said separable block 2; By means of both said additional notch 15 and jut 24, said separable block 2 cab further be precisely positioned and locked in the predetermined destination on said card body 1 with braking function of anti-idle ability so as to prevent such product from failure of normal function due to mistake and inadvertence from the user; As for other structure and assembling way, they are the same as those in the above exemplary embodiment aforesaid in no need of redundant description here.

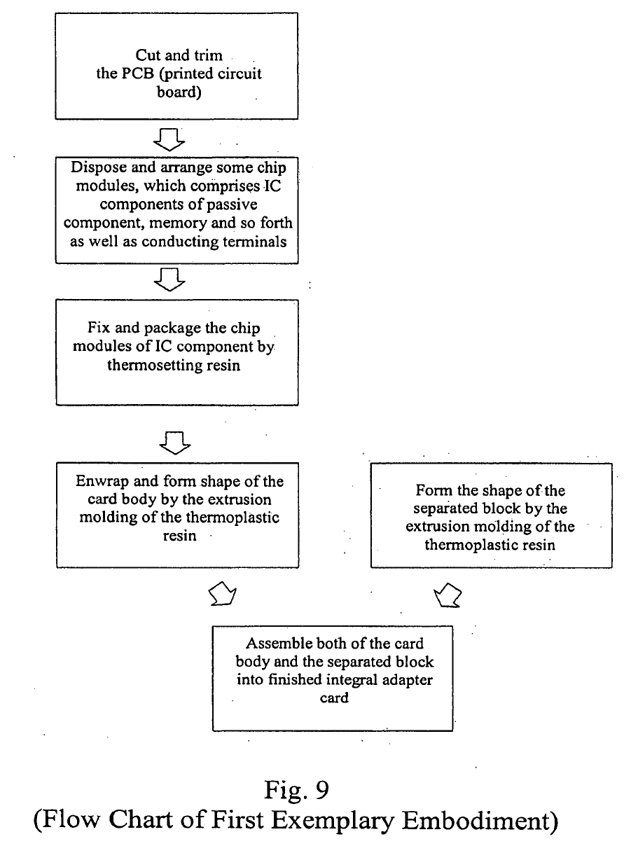

The FIG. 9 is the flow chart of the fabricating process for one preferred embodiment of the present invention. In order to keep the sliding successful smooth and precision in assembly and dismounting of said card body 1 and separable block 2, the plastics material used in said card body 1 and separable block 2 of the present invention is elastic thermoplastic resin with fabricating process is described below in association with the FIG. 9 attached:

First, cut and trim the PCB (printed circuit board); Secondly, dispose and arrange some chip modules, which comprises IC components of passive component, memory and so forth as well as I/O contacts for signal connection; Thirdly, fix and package chip the modules of IC component by thermosetting resin; Owing to employing thermosetting resin as packaging material, the production speed is increased with firmness so that not only the steady package can be effectively achieved but also the product yield can be promoted; Fourthly, enwrap and form shape of the card frame covering the modules of IC component aforesaid by the extrusion molding of the thermoplastic soft resin such as TPE, TPU, TPR and so on with only exposure of the I/O contacts for data and information connection so that the dual interface card shape of the memory card and the universal serial bus (USB) is finished; Meanwhile, form the shape of the separated block by the extrusion molding of the thermoplastic resin; Owing to the elasticity of the thermoplastic resin in forming the external shell, the adapter card is not only difficult to fracture under pressure but also easy to couple and assemble each other mutually; Finally, assemble both of the card body and the separated block into finished integral adapter card.

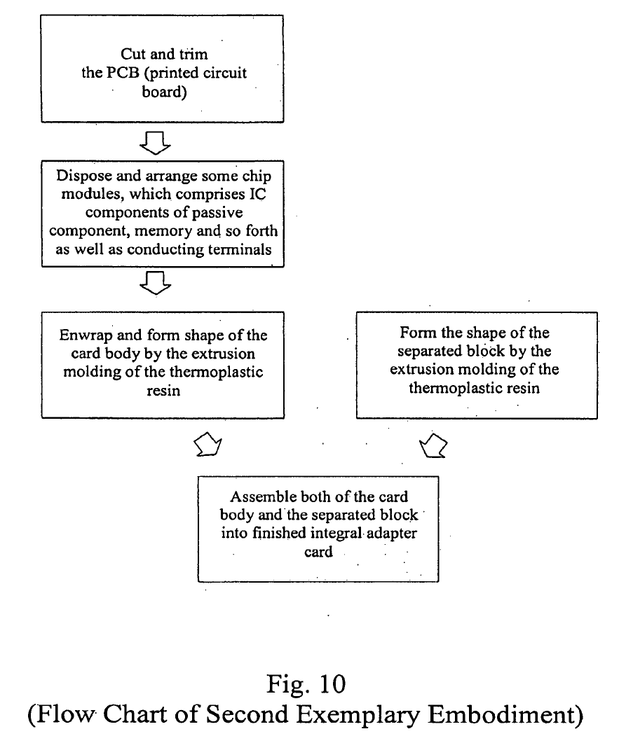

The difference of the flow chart of the fabricating process for other preferred embodiment of the present invention in the FIG. 10 from that of the above exemplary embodiment aforesaid is in eliminating and simplifying the fixing and packaging process in third step by directly packaging and forming the card shape by the extrusion molding of the thermoplastic resin.

From the above description, it is known that the feature of the extrusion molding of the thermosetting and thermoplastic resin is amply developed by the present invention so that not only the fabricated adapter card has the advantage of thermosetting and thermoplastic resin but also the production quantity and quality can be increased; Especially, the particular contrivance of the present invention can be coordinately used in the industrial application, which has never disclosed publicly; Thus, the present invention conforms to the essential patent requirement and criterion of novelty and non-obviousness stipulated in the patent laws.

Accordingly, we submit the present invention for patent application in new type; please favor us by granting award of patent, which will be greatly appreciated by us.

However, all the disclosure and description mentioned above, which is only for the preferred exemplary embodiments of the present invention, is not to be used to limit the range of the present invention; Any simple and equivalent change, alteration, adjustment and modification within the scope of the claims of the present invention is implied being covered by the range of the present invention.

What is claimed is:

1. A new type structure of an adapter card comprises:
(1) a card body, master card, which being made of thermoplastic resin, has a chip module mounted as well as the memory card specification and a set of exposed I/O contacts of said chip module disposed at one end of said card body; A cut recess, which being formed at the other end of said card body, has an indented second insertion slot disposed on each of both sides forming the right angle in said cut recess; Other than said cut recess, the rest part of said card body, which conforming to the size of the universal serial bus USB, has a pair of horizontal parallel indented first insertion slots juxtaposed on one surface of said card body as well as has a set of I/O contacts formed on the inverted surface said card body; and
(2) a separable block, sub-card, which being made of thermoplastic resin whit shape conforming to the outline of said cut recess on said card body, has a second fastener for coupling with the corresponding said indented second insertion slot on said cut recess of said card body disposed on one of both sides forming the right angle in said separated block as well as has a pair of first fasteners juxtaposed on one surface of said separated block for coupling with the corresponding said pair of first insertion slots on said card body;
Thereby, said separable block can be selectively stacked on or alternately removed from said card body after dismounting it from said card body in accordance with the thickness of the card in order to meet the thickness of the USB port so that the dual interface adapter card of memory card specification and the USB specification is finished.

2. A new type structure of an adapter card as recited in the claim 1, wherein the chip module in said card body is first packaged in the thermosetting resin and further enwrapped by another thermoplastic resin externally so as to form a card shape.

3. A new type structure of an adapter card as recited in the claim 1, wherein the chip module in said card body is packaged and enwrapped in the thermoplastic resin so as to form a card shape.

4. A new type structure of an adapter card as recited in the claim 1, wherein, the coupling combination for the pair of first fasteners on the side of said cut recess in said card body and pair of first insertion slots in said separable block can be contrived as convex-one with concave-one sliding insertion card set.

5. A new type structure of an adapter card as recited in the claim 1, wherein, a notch and a jut are respectively created on said card body and said separable block so as to let both couple and lock each other mutually during stacking combination.

6. A new type structure of an adapter card as recited in the claim 4, wherein, the pair of juxtaposed first fasteners is contrived as stout-one with slim-one set manner in different specifications

7. A new type structure of an adapter card as recited in the claim 6, wherein, the pair of juxtaposed first fasteners is arranged in both-in-same-direction manner.

8. A new type structure of an adapter card as recited in the claim 6, wherein, the pair of juxtaposed first fasteners is arranged in back-to-back-direct-outward manner.

9. A new type structure of an adapter card as recited in the claim 6, wherein, the pair of juxtaposed first fasteners in face-to-face-direct-inward manner.
